(19) United States
(12) Patent Application Publication
(10) Pub. No.: US 2025/0189453 A1
(43) Pub. Date: Jun. 12, 2025

(54) SPECTROSCOPIC DEVICE, RAMAN SPECTROSCOPIC MEASUREMENT DEVICE, AND SPECTROSCOPIC METHOD

(71) Applicant: HAMAMATSU PHOTONICS K.K., Hamamatsu-shi, Shizuoka (JP)

(72) Inventors: Kazuya IGUCHI, Hamamatsu-shi, Shizuoka (JP); Hideki MASUOKA, Hamamatsu-shi, Shizuoka (JP); Kenichi OHTSUKA, Hamamatsu-shi, Shizuoka (JP)

(73) Assignee: HAMAMATSU PHOTONICS K.K., Hamamatsu-shi, Shizuoka (JP)

(21) Appl. No.: 18/855,479

(22) PCT Filed: Dec. 19, 2022
(86) PCT No.: PCT/JP2022/046729

§ 371 Date: Oct. 9, 2024

(30) Foreign Application Priority Data
May 27, 2022 (JP) 2022-086947

(51) Int. Cl. G01N 21/65

(52) U.S. Cl. CPC G01N 21/65

(57) ABSTRACT

A spectroscopic device receives light wavelength-resolved in a predetermined direction by a spectroscopic optical system including a spectroscopic element to acquire spectroscopic spectrum data of the light, and the spectroscopic device includes: a CCD type imaging element including a pixel unit including a plurality of pixels arranged in a row direction along a wavelength resolution direction of the light and in a column direction perpendicular to the row direction, an accumulation unit arranged for each column at an end portion in the column direction of the pixel unit and accumulating charges generated in pixels of each column, and a readout unit outputting an electrical signal of each column corresponding to a magnitude of the charge accumulated in the accumulation unit; a semiconductor element converting the electrical signal of each column into a digital signal and outputting the digital signal; and a generation unit generating spectroscopic spectrum data on the basis of the digital signal.

### TECHNICAL FIELD

The present disclosure relates to a spectroscopic device, a Raman spectroscopic measurement device, and a spectroscopic method.

### BACKGROUND ART

As a conventional spectroscopic device, for example, a spectroscopic device described in Patent Literature 1 is mentioned. This conventional spectroscopic device is a so-called Raman spectroscopic device. The spectroscopic device includes a means for linearly irradiating excitation light, a movable stage on which a sample is placed, an objective lens focusing Raman light from an excitation light irradiation region, a slit provided at an image forming position of the Raman light, a spectroscope dispersing light passing through the slit, a CCD detector detecting a Raman spectrum image, and a control device controlling mapping measurement by synchronization between the movable stage and the CCD detector.

### CITATION LIST

### Patent Literature

Patent Literature 1: Japanese Unexamined Patent Publication No. 2016-180732

### SUMMARY OF INVENTION

### Technical Problem

In the field of spectroscopic measurement such as Raman spectroscopy, fluorescence spectroscopy, and plasma spectroscopy, vertical binning of a CCD image sensor is used to acquire spectroscopic spectrum data in order to improve an SN ratio of a signal. In the vertical binning in the CCD image sensor, charges generated in each pixel are added for a plurality of stages. In the CCD image sensor, readout noise is generated only in an amplifier of the final stage, and does not increase in the process of vertical binning. Therefore, as the number of stages of vertical binning increases, the SN ratio of the signal can be improved.

As the image sensor, in addition to CCD, a CMOS image sensor is also known. However, at present, CMOS image sensors are not widely used in the field of spectroscopic measurement. In the CMOS image sensor, an amplifier is arranged in each pixel, and a charge is converted into a voltage for each pixel. In the case of performing vertical binning by a conventional CMOS image sensor, since readout noise is also integrated as the number of stages of vertical binning increases, there is a problem in that an SN ratio of a signal is lower than that in the case of using a CCD image sensor.

The present disclosure has been made to solve the above problems, and an object thereof is to provide a spectroscopic device, a Raman spectroscopic measurement device, and a spectroscopic method capable of acquiring spectroscopic spectrum data with an excellent SN ratio.

### Solution to Problem

The gist of a Raman spectroscopic measurement device and a spectroscopic method according to an aspect of the present disclosure is as described in the following [1] to [10].

[1] A spectroscopic device receiving light wavelength-resolved in a predetermined direction by a spectroscopic optical system including a spectroscopic element to acquire spectroscopic spectrum data of the light, the spectroscopic device including: a CCD type imaging element including: a pixel unit including a plurality of pixels arranged in a row direction along a wavelength resolution direction of the light and in a column direction perpendicular to the row direction, an accumulation unit arranged for each column at an end portion in the column direction of the pixel unit and accumulating charges generated in pixels of each column, and a readout unit outputting an electrical signal of each column corresponding to a magnitude of the charges accumulated in the accumulation unit; a semiconductor element converting the electrical signal of each column output from the readout unit into a digital signal and outputting the digital signal; and a generation unit generating spectroscopic spectrum data on the basis of the digital signal output from the semiconductor element.

In this spectroscopic device, the wavelength-resolved light is received by the plurality of pixels arranged in the row direction and in the column direction, charges generated in the pixels of each column are accumulated, and then an electrical signal of each column corresponding to a magnitude of the charges is output. Since these processes are performed by the CCD type imaging element, it is possible to avoid an increase in readout noise when charges generated in the pixels of each column are read. Furthermore, in outputting the digital signal based on the electrical signal of each column, reading speed is faster than in the case of providing a horizontal transfer circuit, and noise due to heat generation is also suppressed. Therefore, in this spectroscopic device, the spectroscopic spectrum data can be acquired with an excellent SN ratio.

[2] The spectroscopic device described in [1], wherein the imaging element includes: a first pixel unit and a second pixel unit divided in the column direction, a first accumulation unit and a second accumulation unit, the first accumulation unit being arranged for each column at an end portion in the column direction of the first pixel unit and accumulating charges generated in pixels of each column, and the second accumulation unit being arranged for each column at an end portion in the column direction of the second pixel unit and accumulating charges generated in pixels of each column, and a first readout unit and a second readout unit, the first readout unit outputting a first electrical signal corresponding to a magnitude of the charges accumulated in the first accumulation unit, and the second readout unit outputting a second electrical signal corresponding to a magnitude of the charges accumulated in the second accumulation unit, and the semiconductor element includes: a first conversion unit converting the first electrical signal of each column output from the first readout unit into a digital signal and outputting the digital signal, and a second conversion unit converting the second electrical signal of each column output from the second readout unit into a digital signal and outputting the digital signal. In this case, the first pixel unit and the second pixel unit can be selectively used according to the mode of the spectroscopic spectrum image. Therefore, spectroscopic spectrum data of various types of light can be acquired with a favorable SN ratio.

[3] The spectroscopic device described in [2], wherein a first exposure time of each pixel belonging to the first pixel unit is shorter than a second exposure time of each pixel belonging to the second pixel unit. According to this configuration, for example, spectroscopic spectrum images of light having different intensities depending on wavelengths can be acquired in different exposure times in the first pixel unit and the second pixel unit. By combining a saturation wavelength band of spectroscopic spectrum data acquired with a short exposure time in the first pixel unit and a non-saturation wavelength band of spectroscopic spectrum data acquired with a long exposure time in the second pixel unit, spectroscopic spectrum data with a favorable SN ratio can be acquired in a high dynamic range.

[4] The spectroscopic device described in [3], wherein image data of a plurality of frames is acquired in the first pixel unit during a period in which image data of one frame is acquired in the second pixel unit. In this case, even in the case of setting different exposure times for the first pixel unit and the second pixel unit, the readout noise of the pixels in each column can be made uniform between the first pixel unit and the second pixel unit. Therefore, the SN ratio of the spectroscopic spectrum data can be stably improved.

[5] The spectroscopic device described in [1], wherein the imaging element includes: a first pixel unit and a second pixel unit divided in the row direction, a first accumulation unit and a second accumulation unit, the first accumulation unit being arranged for each column at an end portion in the column direction of the first pixel unit and accumulating charges generated in pixels of each column, and the second accumulation unit being arranged for each column at an end portion in the column direction of the second pixel unit and accumulating charges generated in pixels of each column, and a first readout unit and a second readout unit, the first readout unit outputting a first electrical signal corresponding to a magnitude of the charges accumulated in the first accumulation unit, and the second readout unit outputting a second electrical signal corresponding to a magnitude of the charges accumulated in the second accumulation unit. In this case, the first pixel unit and the second pixel unit can be selectively used according to the mode of the spectroscopic spectrum image. Therefore, spectroscopic spectrum data of various types of light can be acquired with a favorable SN ratio.

[6] The spectroscopic device described in [5], wherein the first readout unit outputs the first electrical signal of each column at a stage where charges generated in pixels corresponding to a first number of rows are accumulated in the first accumulation unit, and the second readout unit outputs the second electrical signal of each column at a stage where charges generated in pixels corresponding to a second number of rows smaller than the first number of rows are accumulated in the second accumulation unit. In this case, spectroscopic spectrum data with a favorable SN ratio can be acquired in a high dynamic range while the exposure time of each pixel belonging to the first pixel unit and the exposure time of each pixel belonging to the second pixel unit are kept equal to each other.

[7] The spectroscopic device described in any one of [1] to [6], further including an analysis unit analyzing the spectroscopic spectrum data. In this case, the spectroscopic device is provided with a spectroscopic spectrum data analysis function, so that convenience is improved.

[8] The spectroscopic device described in any one of [1] to [7], further including the spectroscopic optical system including the spectroscopic element. In this case, the spectroscopic device is provided with a wavelength resolution function of the light, so that convenience is improved.

[9] A Raman spectroscopic measurement device including: the spectroscopic device described in any one of [1] to [8]; a light source unit generating light with which a sample is irradiated; and a light guiding optical system guiding Raman scattered light generated by irradiating the sample with the light to the spectroscopic device.

In this Raman spectroscopic measurement device, the wavelength-resolved Raman scattered light is received by the plurality of pixels arranged in the row direction and in the column direction, charges generated in the pixels of each column are accumulated, and then an electrical signal of each column corresponding to a magnitude of the charges is output. Since these processes are performed by the CCD type imaging element, it is possible to avoid an increase in readout noise when charges generated in the pixels of each column are read. Furthermore, in outputting the digital signal based on the electrical signal of each column, reading speed is faster than in the case of providing a horizontal transfer circuit, and noise due to heat generation is also suppressed. Therefore, in this Raman spectroscopic measurement device, the spectroscopic spectrum data can be acquired with an excellent SN ratio.

[10] A spectroscopic method of receiving light wavelength-resolved in a predetermined direction to acquire spectroscopic spectrum data of the light, the spectroscopic method including: a light receiving step of receiving the wavelength-resolved light by a plurality of pixels arranged in a row direction along a wavelength resolution direction and in a column direction perpendicular to the row direction; an accumulating step of accumulating charges generated in pixels of each column; a readout step of outputting an electrical signal of each column corresponding to a magnitude of the accumulated charges; a converting step of converting the electrical signal of each column into a digital signal and outputting the digital signal; and a generating step of generating spectroscopic spectrum data on the basis of the digital signal.

In this spectroscopic method, the wavelength-resolved light is received by the plurality of pixels arranged in the row direction and in the column direction, charges generated in the pixels of each column are accumulated, and then an electrical signal of each column corresponding to a magnitude of the charges is output. Thereby, it is possible to avoid an increase in readout noise when charges generated in the pixels of each column are read. Furthermore, in outputting the digital signal based on the electrical signal of each column, reading speed is increased, and noise due to heat generation is also suppressed. Therefore, in this spectroscopic method, the spectroscopic spectrum data can be acquired with an excellent SN ratio.

### Advantageous Effects of Invention

According to the present disclosure, the spectroscopic spectrum data can be acquired with an excellent SN ratio.

### BRIEF DESCRIPTION OF DRAWINGS

FIG. 1 is a block diagram illustrating a configuration of a Raman spectroscopic measurement device according to an embodiment of the present disclosure.

FIG. 2 is a schematic view illustrating an example of a pixel unit.

FIG. 3 is a schematic graph showing an example of spectroscopic spectrum data acquired by a spectroscopic device.

FIG. 4 is a view illustrating a structure of an imaging sensor.

FIG. 5 is a view illustrating the structure of the imaging sensor.

FIG. 6 is a schematic cross-sectional view illustrating a peripheral structure of an accumulation unit.

FIG. 7 is a view illustrating a structure of a semiconductor element.

FIG. 8 is a view illustrating the structure of the semiconductor element.

FIG. 9 is a schematic view illustrating a relationship between an exposure time of each pixel belonging to a first imaging unit and an exposure time of each pixel belonging to a second imaging unit.

FIG. 10 is a flowchart illustrating a spectroscopic method according to an embodiment of the present disclosure.

FIG. 11 is a schematic view illustrating a pixel unit of a spectroscopic device according to a modification.

FIG. 12 is a graph showing an example of a spectrum of light incident on the spectroscopic device according to the modification.

FIG. 13 is a graph showing an example of first spectrum data and second spectrum data acquired by the spectroscopic device according to the modification.

FIG. 14 is a graph showing an example of spectrum data generated from the first spectrum data and the second spectrum data shown in FIG. 13.

FIG. 15 is a schematic view illustrating a state of forming a spectroscopic spectrum image in the spectroscopic device according to the modification.

### DESCRIPTION OF EMBODIMENTS

Hereinafter, preferred embodiments of a spectroscopic device, a Raman spectroscopic measurement device, and a spectroscopic method according to an aspect of the present disclosure will be described in detail with reference to the drawings.

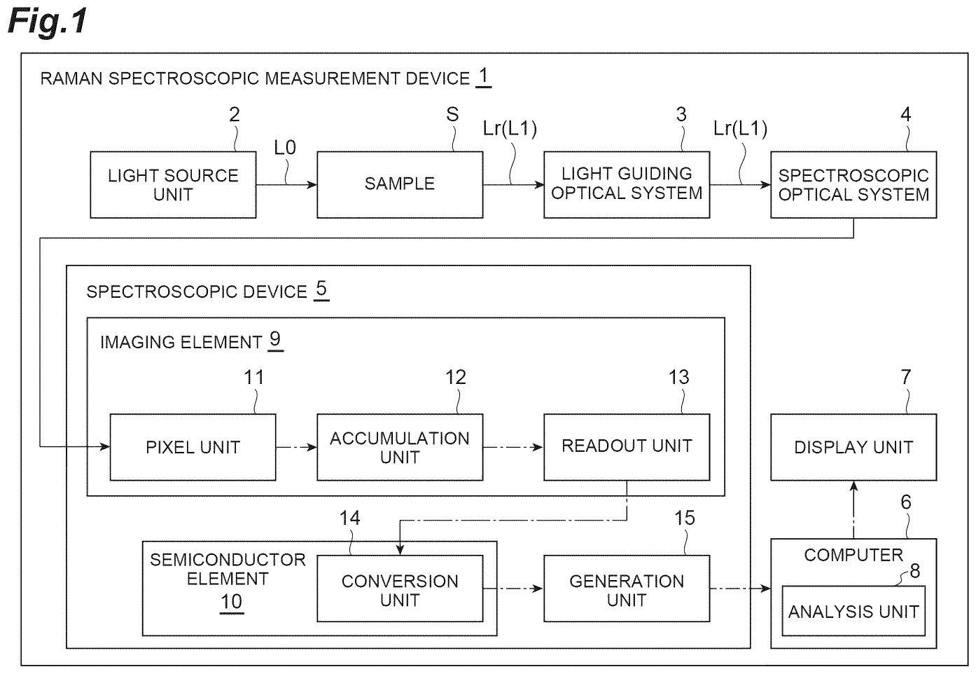

FIG. 1 is a block diagram illustrating a configuration of a Raman spectroscopic measurement device according to an embodiment of the present disclosure. A Raman spectroscopic measurement device 1 is a device measuring physical properties of a sample S by using Raman scattered light Lr. In the Raman spectroscopic measurement device 1, the sample S is irradiated with light L1 from a light source unit 2, the Raman scattered light Lr generated by an interaction between the light L1 and the sample S is detected by a spectroscopic device 5, and spectroscopic spectrum data of the Raman scattered light Lr is acquired. By analyzing the spectroscopic spectrum data acquired by the spectroscopic device 5 with a computer 6, various physical properties such as the molecular structure, crystallinity, orientation, and distortion amount of the sample S can be evaluated. Examples of the sample S include semiconductor materials, polymers, cells, and pharmaceuticals.

As illustrated in FIG. 1, the Raman spectroscopic measurement device 1 includes the light source unit 2, a light guiding optical system 3, a spectroscopic optical system 4, the spectroscopic device 5, the computer 6, and a display unit 7. In the following description, for convenience, light incident on the spectroscopic device 5 through the spectroscopic optical system 4 may be referred to as the light L1 to be distinguished from the Raman scattered light Lr. In the spectroscopic device 5 incorporated in the Raman spectroscopic measurement device 1, the light L1 refers to the Raman scattered light Lr.

The light source unit 2 is a portion generating light L0 with which the sample S is irradiated. As a light source constituting the light source unit 2, for example, a laser light source serving as an excitation light source for Raman spectroscopy, a light emitting diode, or the like can be used. The light guiding optical system 3 is a portion guiding the Raman scattered light Lr generated by irradiating the sample S with the light L0 to the spectroscopic device 5. The light guiding optical system 3 includes, for example, a collimating lens, one or a plurality of mirrors, a slit, and the like.

The spectroscopic optical system 4 is a portion wavelength-resolving the light L1 in a predetermined direction. The spectroscopic optical system 4 includes a spectroscopic element dispersing the light L1 in a predetermined wavelength resolution direction. As the spectroscopic element, for example, a prism, a diffraction grating (grating), a concave diffraction grating, a crystal spectroscopic element, and the like can be used. The Raman scattered light Lr is dispersed by the spectroscopic optical system 4 and input to the spectroscopic device 5.

In FIG. 1, the spectroscopic optical system 4 is configured separately from the spectroscopic device 5, but the spectroscopic optical system 4 may be incorporated as a constituent element of the spectroscopic device 5. That is, the spectroscopic device 5 may further include the spectroscopic optical system 4 including a spectroscopic element that disperses the light L1 in the wavelength resolution direction. In this case, the spectroscopic device 5 is provided with a wavelength resolution function of the light L1, so that convenience is improved. The spectroscopic device 5 is a portion receiving the light L1 wavelength-resolved in a predetermined direction to output spectroscopic spectrum data of the light L1. In the present embodiment, the spectroscopic device 5 receives the Raman scattered light Lr dispersed in a predetermined wavelength resolution direction by the spectroscopic optical system 4 and outputs spectroscopic spectrum data of the Raman scattered light Lr to the computer 6.

The computer 6 physically includes a storage device such as a RAM or a ROM, a processor (arithmetic circuit) such as a CPU, a communication interface, and the like. As the computer 6, for example, a personal computer, a cloud server, or a smart device (smartphone, tablet terminal, or the like) can be used. The computer 6 is connected to the light source unit 2 of the Raman spectroscopic measurement device 1 and the spectroscopic device 5 so as to be able to communicate information with one another, and can integrally control these constituent elements. The computer 6 also functions as an analysis unit 8 analyzing physical properties of the sample S on the basis of the spectroscopic spectrum data received from the spectroscopic device 5 (generation unit 15). The computer 6 outputs information indicating the analysis result of the analysis unit 8 to the display unit 7.

As illustrated in FIG. 1, the spectroscopic device 5 includes a pixel unit 11, an accumulation unit 12, a readout unit 13, a conversion unit 14, and the generation unit 15. The pixel unit 11, the accumulation unit 12, and the readout unit 13 are configured by an imaging element 9. The conversion unit 14 includes a semiconductor element 10. The imaging element 9 is, for example, a solid-state imaging element including a charge coupled device (CCD) type charge coupled element. The semiconductor element 10 includes, for example, a complementary metal oxide semiconductor (CMOS) type semiconductor chip, and functions as the conversion unit 14 by a circuit built in the semiconductor chip.

In the present embodiment, the spectroscopic device 5 is configured as a camera including the imaging element 9, the semiconductor element 10, and the generation unit 15. Here, the spectroscopic device 5 is separated from the computer 6, but the spectroscopic device 5 may be configured to integrally include the camera including the imaging element 9, the semiconductor element 10, and the generation unit 15, and the computer 6 (analysis unit 8) connected to the camera so as to be able to communicate information with each other electrically or wirelessly. In this case, the computer 6 may function as the generation unit 15 and the analysis unit 8.

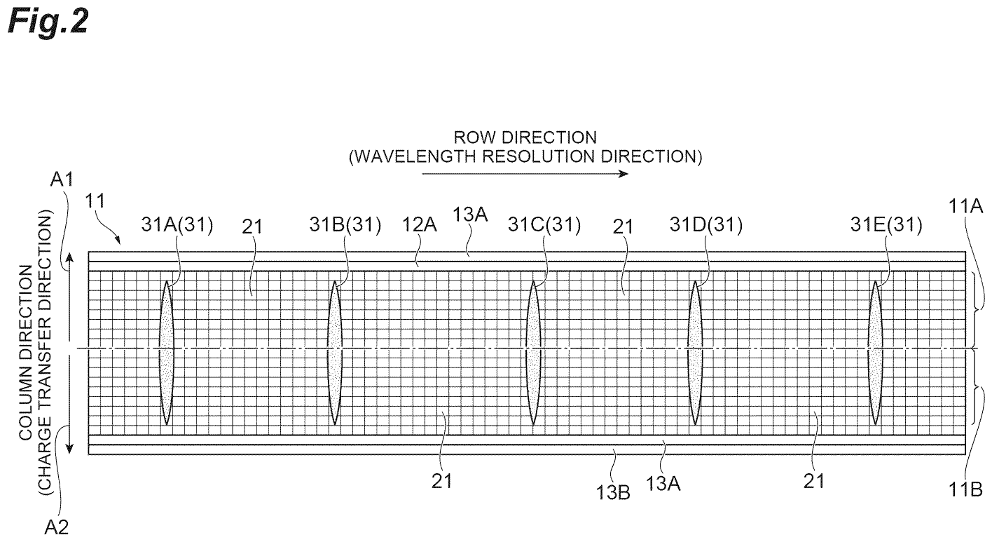

FIG. 2 is a schematic view illustrating an example of a pixel unit. As illustrated in FIG. 2, in the pixel unit 11, a plurality of pixels 21 arranged in a row direction and a column direction perpendicular to the row direction. Here, the row direction is along the wavelength resolution direction of the light L1 or the Raman scattered light Lr by the spectroscopic optical system 4, and the column direction is along a charge transfer direction of the pixel 21. The each pixel 21 receives the wavelength-resolved light L1 or the Raman scattered light Lr to generate and accumulate a charge according to the intensity of the light.

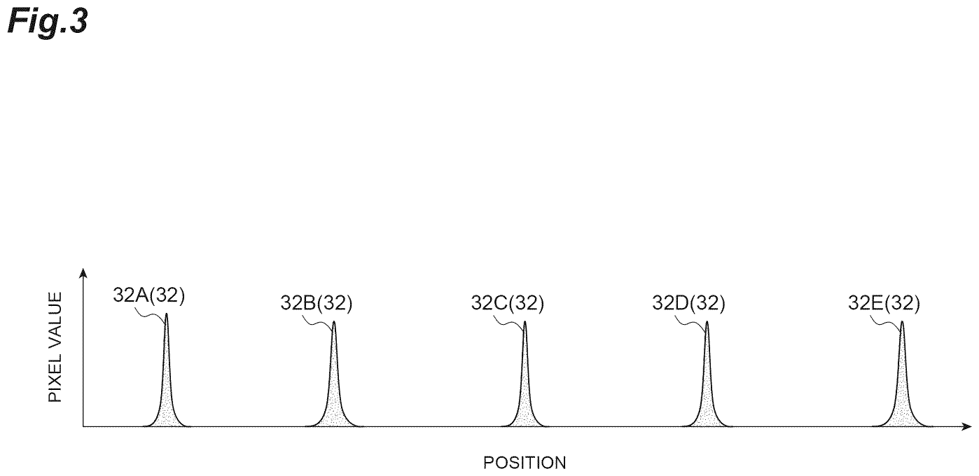

In the example of FIG. 2, the pixel unit 11 has a horizontally long shape in which the number of pixels in the row direction is larger than the number of pixels in the column direction. Five spectroscopic spectrum images 31 (31A to 31E from the short wavelength side) are formed with respect to the pixel unit 11. Each of the spectroscopic spectrum images 31A to 31E linearly extends in the column direction of the pixel 21 and is formed on the pixel unit 11 in a state of being separated from each other in the row direction. In this case, for example, as shown in FIG. 3, in the spectroscopic device 5, the spectroscopic spectrum data items 32 (32A to 32E) corresponding to the spectroscopic spectrum images 31A to 31E are generated. The generated spectroscopic spectrum data items 32 (32A to 32E) are output from the spectroscopic device 5 (generation unit 15) to the computer 6.

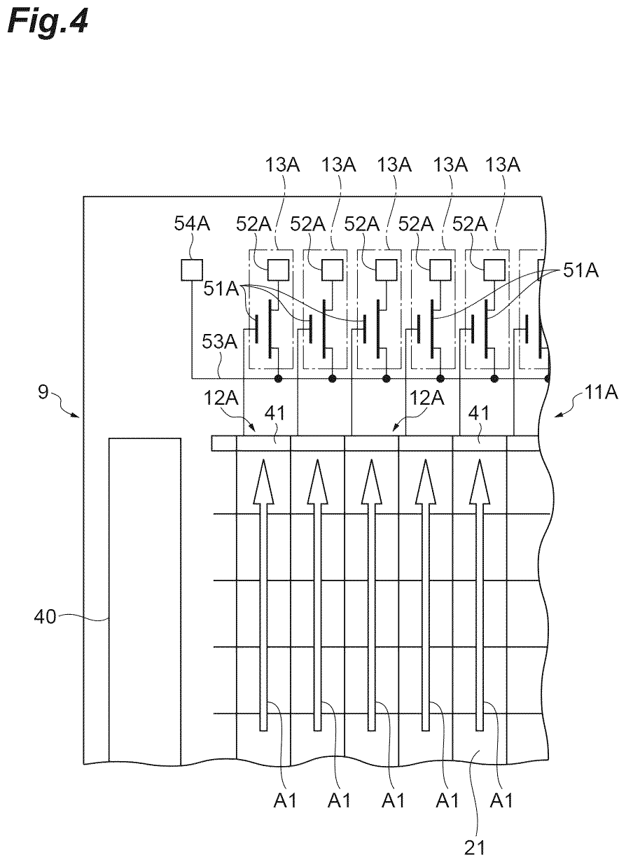

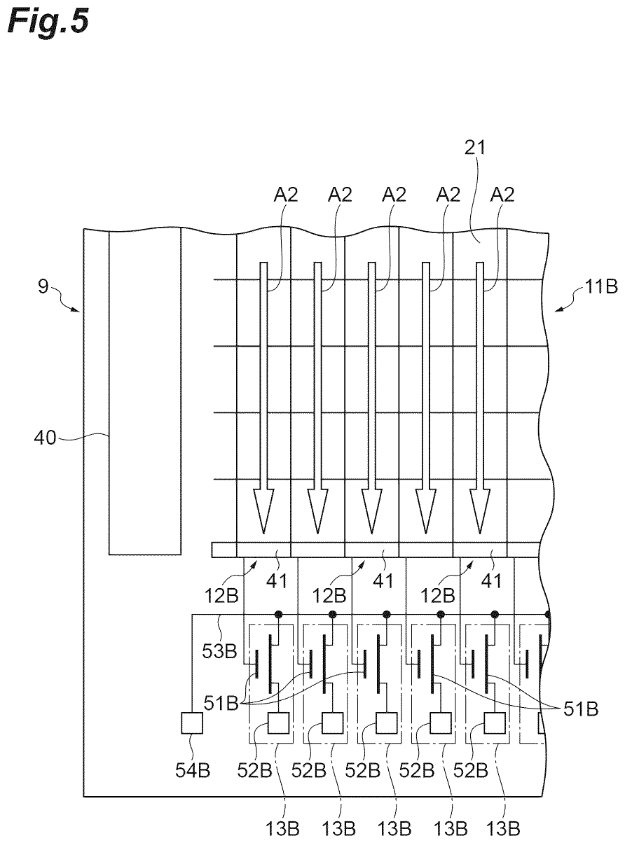

As described above, the imaging element 9 includes the pixel unit 11, the accumulation unit 12, and the readout unit 13. The pixel unit 11 is a portion capturing the spectroscopic spectrum image 31 of the light L1 or the Raman scattered light Lr formed by the spectroscopic optical system 4. In the present embodiment, as illustrated in FIG. 4 and FIG. 5, the imaging element 9 includes a first pixel unit 11A and a second pixel unit 11B divided in the column direction. The first pixel unit 11A and the second pixel unit 11B are divided at the center in the column direction (see FIG. 2). That is, the pixel 21 on one side of the center in the column direction belongs to the first pixel unit 11A, and the pixel 21 on the other side of the center in the column direction belongs to the second pixel unit 11B.

The imaging element 9 includes a conversion substrate 40 for a drive pad controlling transfer of charges in the first pixel unit 11A and the second pixel unit 11B. The conversion substrate 40 is disposed, for example, beside the pixel unit 11 along the column direction. A voltage signal (drive voltage) for controlling transfer of charges of the pixel 21 is supplied to the conversion substrate 40. The charge of the pixel 21 of each column belonging to the first pixel unit 11A is transferred in the direction of the arrow A1 in FIG. 4 along the column direction on the basis of the voltage signal supplied to the conversion substrate 40. The charge of the pixel 21 of each column belonging to the second pixel unit 11B is transferred in the direction of the arrow A2 in FIG. 5 (direction opposite to the arrow A1) along the column direction on the basis of the voltage signal supplied to the conversion substrate 40.

The accumulation unit 12 is a portion accumulating charges generated in the pixels 21 of each column. The accumulation unit 12 is arranged for each column at an end portion in the column direction of the pixel unit 11. In the present embodiment, the imaging element 9 includes a first accumulation unit 12A (see FIG. 4) corresponding to the first pixel unit 11A and a second accumulation unit 12B (see FIG. 5) corresponding to the second pixel unit 11B. The first accumulation unit 12A is arranged for each column at an end portion in the column direction of the first pixel unit 11A, and accumulates charges generated in the pixels 21 of each column belonging to the first pixel unit 11A. The second accumulation unit 12B is arranged for each column at an end portion in the column direction of the second pixel unit 11B, and accumulates charges generated in the pixels 21 of each column belonging to the second pixel unit 11B. The first accumulation unit 12A is arranged at a first end portion of the pixel unit 11 in the column direction (an end portion on the first pixel unit 11A side), and the second accumulation unit 12B is arranged at a second end portion of the pixel unit 11 in the column direction (an end portion on the second pixel unit 11B side) (see FIG. 2).

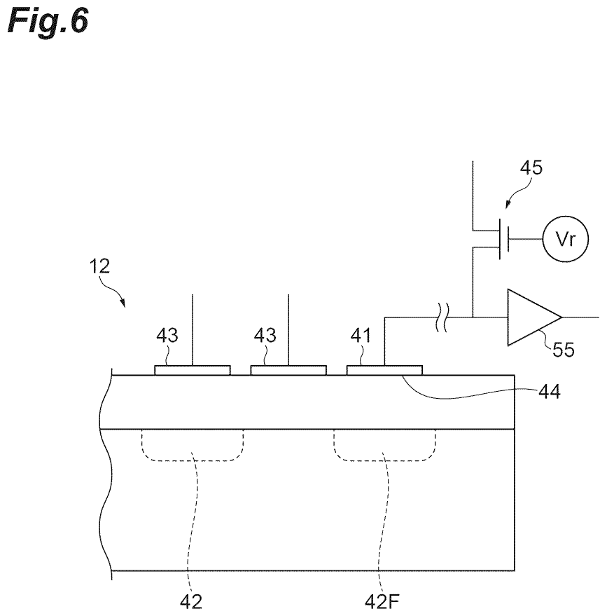

As illustrated in FIG. 6, the accumulation unit 12 includes a floating gate electrode 41. The charge of a potential well 42 of the pixel 21 of each column is transferred to a final potential well 42F of each column by a control gate electrode 43. In the final potential well 42F, for example, charges corresponding to the number of pixels set for each column are accumulated. When the charges corresponding to the number of the set pixels are accumulated in the final potential well 42F, a voltage at a sense node 44 is output to the readout unit 13 via the floating gate electrode 41. After the output, a reset voltage is applied to a reset transistor 45, and the charges accumulated in the final potential well 42F are removed via the reset transistor 45.

The readout unit 13 is a portion outputting an electrical signal of each column corresponding to a magnitude of the charges accumulated in the accumulation unit 12. In the present embodiment, the imaging element 9 includes a plurality of first readout units 13A respectively corresponding to the first accumulation unit 12A and a plurality of second readout units 13B respectively corresponding to the second accumulation unit 12B. The first readout unit 13A is arranged at the subsequent stage of the first accumulation unit 12A at the first end portion of the pixel unit 11 in the column direction (the end portion on the first pixel unit 11A side), and the second readout unit 13B is arranged at the subsequent stage of the second accumulation unit 12B at the second end portion of the pixel unit 11 in the column direction (the end portion on the second pixel unit 11B side) (see FIG. 2). The first readout unit 13A outputs a first electrical signal of each column corresponding to a magnitude of the charges accumulated in the first accumulation unit 12A. The second readout unit 13B outputs a second electrical signal of each column corresponding to a magnitude of the charges accumulated in the second accumulation unit 12B.

As illustrated in FIG. 4, the first readout unit 13A includes a transistor 51A and a bonding pad 52A for signal output. A control terminal (gate) of the transistor 51A is electrically connected to the first accumulation unit 12A. One current terminal (drain) of the transistor 51A is electrically connected to a bonding pad 54A via a wiring 53A provided in common over each column of the first pixel unit 11A. A voltage of a predetermined magnitude is applied to the bonding pad 54A at all times.

The other current terminal (source) of the transistor 51A is electrically connected to the bonding pad 52A for signal output. A voltage corresponding to the first electrical signal output from the first accumulation unit 12A is applied to the control terminal of the transistor 51A. From the other current terminal of the transistor 51A, a current corresponding to the applied voltage is output and taken out via the bonding pad 52A for signal output. The first electrical signal output from the bonding pad 52A for signal output is amplified by an amplifier 55 (see FIG. 6) and then output to the conversion unit 14.

As illustrated in FIG. 5, the second readout unit 13B includes a transistor 51B and a bonding pad 52B for signal output. A control terminal (gate) of the transistor 51B is electrically connected to the second accumulation unit 12B. One current terminal (drain) of the transistor 51B is electrically connected to a bonding pad 54B via a wiring 53B provided in common over each column of the second pixel unit 11B. A voltage of a predetermined magnitude is applied to the bonding pad 54B at all times.

The other current terminal (source) of the transistor 51B is electrically connected to the bonding pad 52B for signal output. A voltage corresponding to the second electrical signal output from the second accumulation unit 12B is applied to the control terminal of the transistor 51B. From the other current terminal of the transistor 51B, a current corresponding to the applied voltage is output and taken out via the bonding pad 52B for signal output. The second electrical signal output from the bonding pad 52B for signal output is amplified by the amplifier 55 (see FIG. 6) and then output to the conversion unit 14.

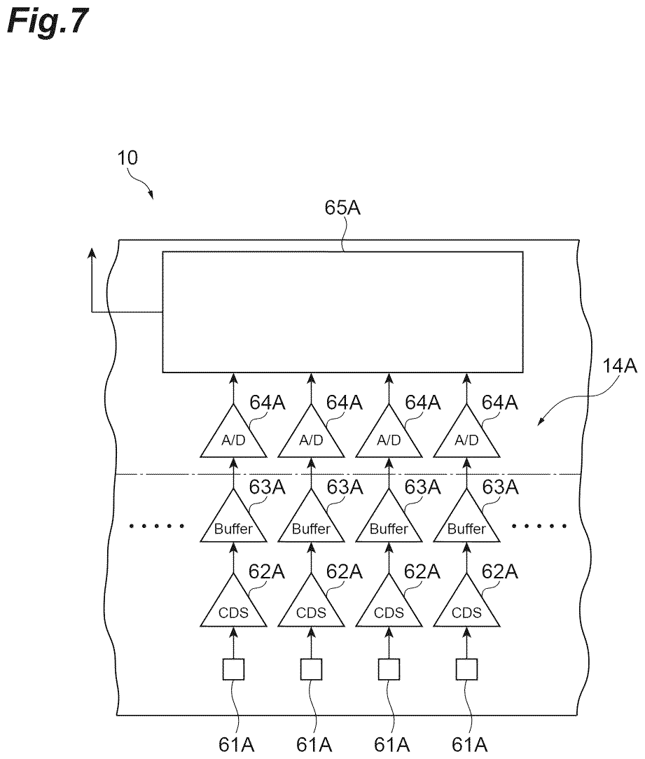

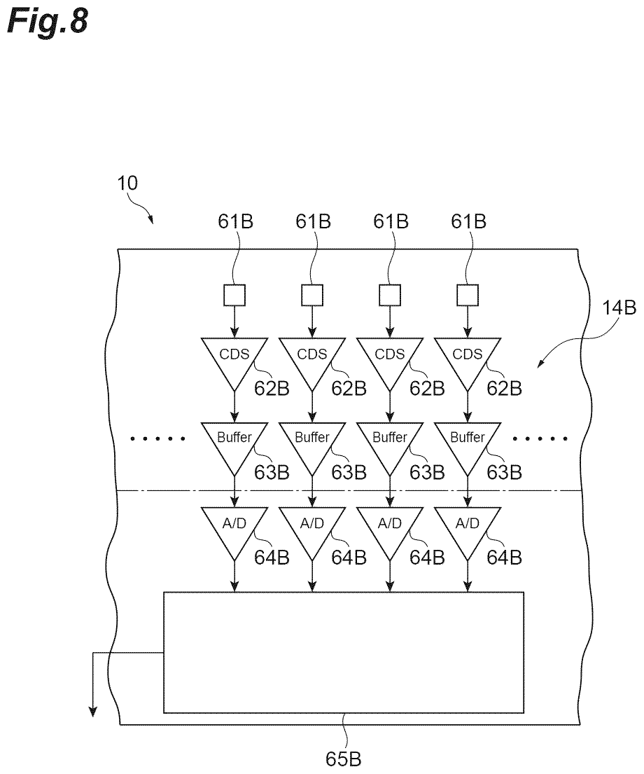

The conversion unit 14 is a portion converting the electrical signal of each column output from the readout unit 13 into a digital signal and outputting the digital signal. In the present embodiment, as illustrated in FIG. 7 and FIG. 8, the semiconductor element 10 includes a plurality of first conversion units 14A respectively corresponding to the first readout unit 13A and a plurality of second conversion units 14B respectively corresponding to the second readout unit 13B. The first conversion unit 14A converts a first electrical signal of each column output from the first readout unit 13A into a digital signal and outputs the digital signal. The second conversion unit 14B converts a second electrical signal of each column output from the second readout unit 13B into a digital signal and outputs the digital signal. The semiconductor element 10 may include a first semiconductor element constituting the first conversion unit 14A and a second semiconductor element constituting the second conversion unit 14B separately.

As illustrated in FIG. 7, the first conversion unit 14A includes a bonding pad 61A, a CDS circuit 62A, a buffer 63A, an A/D conversion circuit 64A, and a multiplexer 65A. The bonding pad 61A is electrically connected to the bonding pad 52A for signal output of the first readout unit 13A. The CDS circuit 62A reduces noise of the first electrical signal input from the bonding pad 61A. The buffer 63A amplifies the first electrical signal input from the CDS circuit 62A. The A/D conversion circuit 64A converts the first electrical signal input from the buffer 63A into a first digital signal. The multiplexer 65A outputs the first digital signal of each column input from each A/D conversion circuit 64A to the generation unit 15.

As illustrated in FIG. 8, the second conversion unit 14B includes a bonding pad 61B, a CDS circuit 62B, a buffer 63B, an A/D conversion circuit 64B, and a multiplexer 65B. The bonding pad 61B is electrically connected to the bonding pad 52B for signal output of the second readout unit 13B. The CDS circuit 62B reduces noise of the second electrical signal input from the bonding pad 61B. The buffer 63A amplifies the second electrical signal input from the CDS circuit 62B. The A/D conversion circuit 64B converts the second electrical signal input from the buffer 63B into a second digital signal. The multiplexer 65B outputs the second digital signal of each column input from each A/D conversion circuit 64B to the generation unit 15.

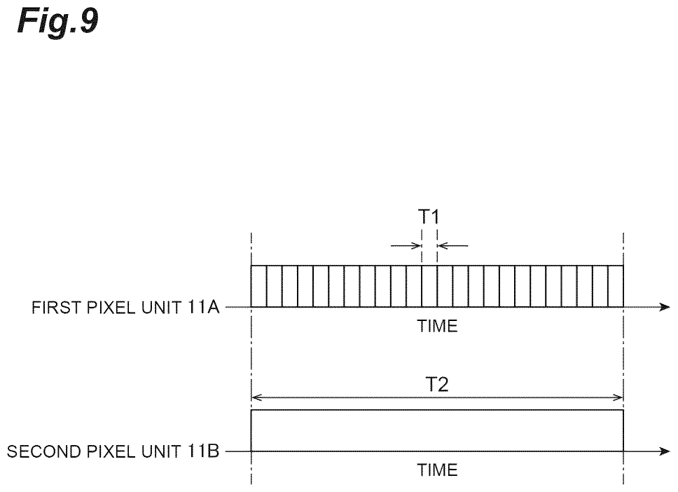

In the present embodiment, in the imaging element 9, a first exposure time T1 of each pixel 21 belonging to the first pixel unit 11A and a second exposure time T2 of each pixel 21 belonging to the second pixel unit 11B are different from each other. More specifically, as illustrated in FIG. 9, the first exposure time T1 of each pixel 21 belonging to the first pixel unit 11A is shorter than the second exposure time T2 of each pixel 21 belonging to the second pixel unit 11B. Therefore, image data of a plurality of frames is acquired in the first pixel region 21A during a period in which image data of one frame is acquired in the second pixel region 21B. In the example of FIG. 9, the second exposure time T2 is an integral multiple of the first exposure time T1. In this example, image data of a frame that is an integral multiple of the second pixel unit 11B is acquired in the first pixel unit 11A during a period in which image data of one frame is acquired in the second pixel unit 11B.

The generation unit 15 is physically configured by a computer system including a storage device such as a RAM or a ROM, a processor (arithmetic circuit) such as a CPU, a communication interface, and the like. The generation unit 15 may include a programmable logic controller (PLC), and may include a field-programmable gate array (FPGA).

The generation unit 15 generates first spectroscopic spectrum data on the basis of the first digital signal input from the first conversion unit 14A. Furthermore, the generation unit 15 generates second spectroscopic spectrum data on the basis of the second digital signal input from the second conversion unit 14B. The first spectroscopic spectrum data is acquired at the relatively short first exposure time T1 in the first pixel unit 11A, and is, for example, equal to or less than a saturation level in all wavelength bands. The second spectroscopic spectrum data is acquired at the relatively long second exposure time T2 in the second pixel unit 11B, and is, for example, equal to or more than a saturation level in a certain wavelength band.

The generation unit 15 divides the wavelength band of the entire spectrum into a saturation wavelength band and a non-saturation wavelength band of the second spectroscopic spectrum data. In the saturation wavelength band, the second spectroscopic spectrum data is equal to or more than the saturation level, and the first spectroscopic spectrum data is less than the saturation level. In the non-saturation wavelength band, the second spectroscopic spectrum data is less than the saturation level and has more favorable S/N ratio than the first spectroscopic spectrum data. The generation unit 15 combines the first spectroscopic spectrum data in the saturation wavelength band and the second spectroscopic spectrum data in the non-saturation wavelength band to generate spectroscopic spectrum data to be output to the computer 6.

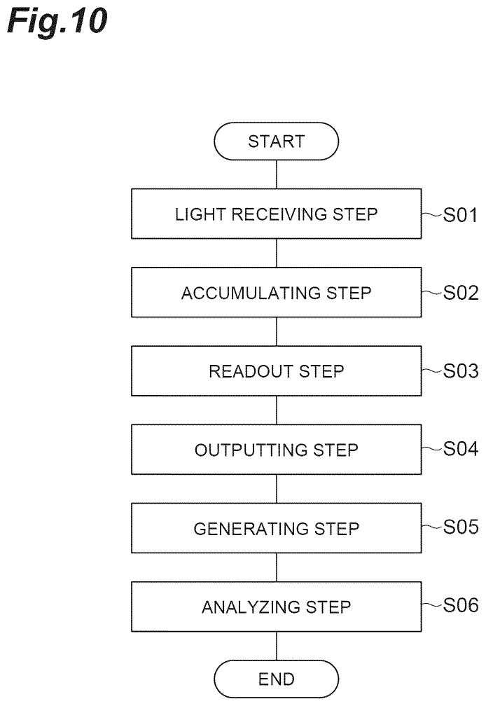

FIG. 10 is a flowchart illustrating a spectroscopic method according to an embodiment of the present disclosure. This spectroscopic method is a method of receiving light wavelength-resolved in a predetermined direction to acquire spectroscopic spectrum data of the light. The spectroscopic method according to the present embodiment is performed using the spectroscopic device 5 described above. As illustrated in FIG. 10, this spectroscopic method includes a light receiving step (step S01), an accumulating step (step S02), a readout step (step S03), a converting step (step S04), a generating step (step S05), and an analyzing step (step S06).

In the light receiving step S01, the wavelength-resolved light L1 or the Raman scattered light Lr is received by the plurality of pixels 21 arranged in the row direction along the wavelength resolution direction and in the column direction perpendicular to the row direction. In the present embodiment, the light L1 or the Raman scattered light Lr is received in different exposure periods in the first pixel unit 11A and the second pixel unit 11B.

In the accumulating step S02, charges generated in the pixels 21 of each column are accumulated. In the present embodiment, the first accumulation unit 12A accumulates charges generated in the pixels 21 of each column belonging to the first pixel unit 11A, and the second accumulation unit 12B accumulates charges generated in the pixels 21 of each column belonging to the second pixel unit 11B. When charges corresponding to the number of pixels set for each column are accumulated in the final potential well 42F, the first accumulation unit 12A and the second accumulation unit 12B output a voltage at the sense node 44 to the readout unit 13 via the floating gate electrode 41. Thereafter, a reset voltage is applied to the reset transistor 45, and the charges accumulated in the final potential well 42F are removed via the reset transistor 45.

In the readout step S03, an electrical signal of each column corresponding to a magnitude of the accumulated charges is output. In the present embodiment, the first readout unit 13A outputs the first electrical signal of each column corresponding to a magnitude of the charges accumulated in the first accumulation unit 12A, and the second readout unit 13B outputs the second electrical signal of each column corresponding to a magnitude of the charges accumulated in the second accumulation unit 12B. The first electrical signal of each column and the second electrical signal of each column are amplified by the amplifier 55 and then output to the conversion unit 14.

In the converting step S04, the electrical signal of each column is converted into a digital signal and the digital signal is output. In the present embodiment, the first conversion unit 14A converts the first electrical signal of each column output from the first readout unit 13A into the first digital signal of each column and outputs the first digital signal, and the second conversion unit 14B converts the second electrical signal of each column output from the second readout unit 13B into the second digital signal of each column and outputs the second digital signal. The first digital signal of each column converted from the first electrical signal of each column by the A/D conversion circuit 64A and the second digital signal of each column converted from the second electrical signal of each column by the A/D conversion circuit 64B are output to the generation unit 15.

In the generating step S05, the spectroscopic spectrum data 32 is generated on the basis of the digital signal. In the present embodiment, in the generation unit 15, the first spectroscopic spectrum data based on the first digital signal and the first spectroscopic spectrum data based on the second digital signal are generated. The generation unit 15 combines the first spectrum data in the saturation wavelength band and the second spectrum data in the non-saturation wavelength band to generate the spectroscopic spectrum data 32 to be output to the computer 6. The generated spectroscopic spectrum data 32 is output to the analysis unit 8.

In the analyzing step S06, the sample S is analyzed on the basis of the spectroscopic spectrum data 32 generated in the generating step S05. For example, the waveform, peak position, half-value width, and the like of the spectroscopic spectrum are analyzed to evaluate various physical properties such as the molecular structure, crystallinity, orientation, and distortion amount of the sample S.

As described above, in the spectroscopic device 5, the wavelength-resolved light L1 is received by the plurality of pixels 21 arranged in the row direction and in the column direction, charges generated in the pixels 21 of each column are accumulated, and then an electrical signal of each column corresponding to a magnitude of the charges is output. Since these processes are performed by the CCD type imaging element 9, it is possible to avoid an increase in readout noise when charges generated in the pixels 21 of each column are read. Furthermore, in outputting the digital signal based on the electrical signal of each column, reading speed is faster than in the case of providing a horizontal transfer circuit, and noise due to heat generation is also suppressed. Therefore, in the spectroscopic device 5, the spectroscopic spectrum data 32 can be acquired with an excellent SN ratio.

In the spectroscopic device 5, the imaging element 9 includes the first pixel unit 11A and the second pixel unit 11B divided in the column direction, the first accumulation unit 12A and the second accumulation unit 12B, the first accumulation unit being arranged for each column at an end portion in the column direction of the first pixel unit 11A and accumulating charges generated in the pixels 21 of each column, and the second accumulation unit being arranged for each column at an end portion in the column direction of the second pixel unit 11B and accumulating charges generated in the pixels 21 of each column, and the first readout unit 13A and the second readout unit 13B, the first readout unit outputting the first electrical signal corresponding to a magnitude of the charges accumulated in the first accumulation unit 12A, and the second readout unit outputting the second electrical signal corresponding to a magnitude of the charges accumulated in the second accumulation unit 12B.

Furthermore, the semiconductor element 10 includes the first conversion unit 14A converting the first electrical signal of each column output from the first readout unit 13A into a digital signal and outputting the digital signal, and the second conversion unit 14B converting the second electrical signal of each column output from the second readout unit 13B into a digital signal and outputting the digital signal. Thereby, the first pixel unit 11A and the second pixel unit 11B can be selectively used according to the mode of the spectroscopic spectrum image 31. Therefore, the spectroscopic spectrum data 32 of various types of light can be acquired with a favorable SN ratio.

In the spectroscopic device 5, the first exposure time T1 of each pixel 21 belonging to the first pixel unit 11A is shorter than the second exposure time T2 of each pixel 21 belonging to the second pixel unit 11B. According to this configuration, for example, spectroscopic spectrum images 31 of light L1 having different intensities depending on wavelengths can be acquired in different exposure times in the first pixel unit 11A and the second pixel unit 11B. In the present embodiment, by combining a saturation wavelength band of first spectroscopic spectrum data acquired with the relatively short exposure time T1 in the first pixel unit 11A and a non-saturation wavelength band of second spectroscopic spectrum data acquired with the relatively long exposure time T2 in the second pixel unit 11B, the spectroscopic spectrum data 32 with a favorable SN ratio can be acquired in a high dynamic range.

In the Raman spectroscopic measurement device 1 configured by incorporating the spectroscopic device 5 described above, the wavelength-resolved Raman scattered light Lr is received by the plurality of pixels 21 arranged in the row direction and in the column direction, charges generated in the pixels 21 of each column are accumulated, and then an electrical signal of each column corresponding to a magnitude of the charges is output. Since these processes are performed by the CCD type imaging element 9, it is possible to avoid an increase in readout noise when charges generated in the pixels 21 of each column are read. Furthermore, in outputting the digital signal based on the electrical signal of each column, reading speed is faster than in the case of providing a horizontal transfer circuit, and noise due to heat generation is also suppressed. Therefore, in the Raman spectroscopic measurement device 1, the spectroscopic spectrum data 32 can be acquired with an excellent SN ratio.

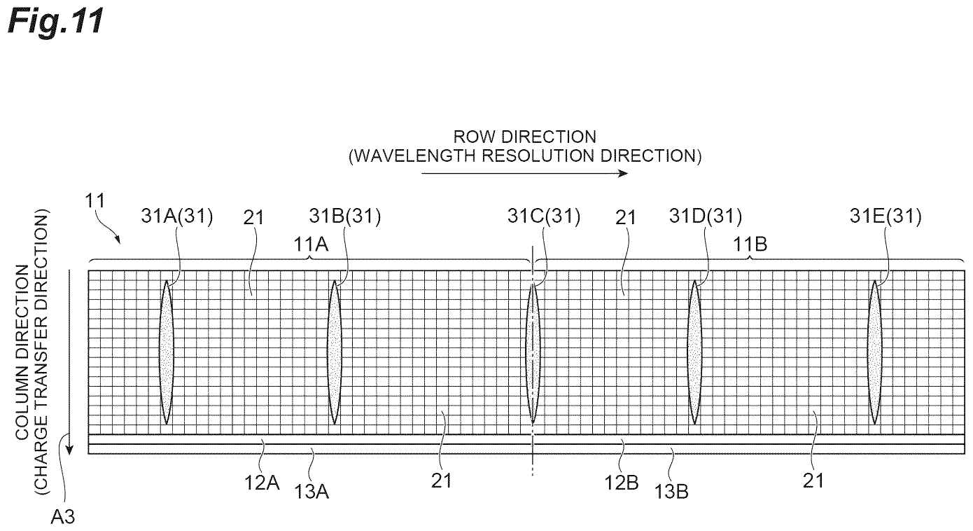

The present disclosure is not limited to the above embodiment, and various modifications can be applied. For example, in the embodiment, the imaging element 9 includes the first pixel unit 11A and the second pixel unit 11B divided in the column direction, but the first pixel unit 11A and the second pixel unit 11B may be divided in the row direction as illustrated in FIG. 11. In FIG. 11, similarly to the case of FIG. 2, the imaging element 9 includes the first accumulation unit 12A and the second accumulation unit 12B, the first accumulation unit being arranged for each column at an end portion in the column direction of the first pixel unit 11A and accumulating charges generated in the pixels 21 of each column, and the second accumulation unit being arranged for each column at an end portion in the column direction of the second pixel unit 11B and accumulating charges generated in the pixels 21 of each column. Furthermore, the imaging element 9 includes the first readout unit 13A and the second readout unit 13B, the first readout unit outputting the first electrical signal of each column corresponding to a magnitude of the charges accumulated in the first accumulation unit 12A, and the second readout unit outputting the second electrical signal of each column corresponding to a magnitude of the charges accumulated in the second accumulation unit 12B.

In the example of FIG. 11, both the first accumulation unit 12A and the second accumulation unit 12B are arranged along one end portion of the pixel unit 11 in the column direction. Both the first readout unit 13A and the second readout unit 13B are arranged at the same end portion at the subsequent stage of the first accumulation unit 12A and the second accumulation unit 12B. That is, in the example of FIG. 11, a charge transfer direction of the pixel 21 belonging to the first pixel unit 11A and a charge transfer direction of the pixel 21 belonging to the second pixel unit 11B are the same direction (both are the arrow A3 direction).

In the present embodiment, the first readout unit 13A and the second readout unit 13B are provided for each column at an end portion in the column direction of each pixel 21 in the pixel unit 11. Therefore, the timing of charge removal and the application of the reset voltage can also be changed for each column. Here, the first exposure time T1 of each pixel 21 belonging to the first pixel unit 11A and the second exposure time T2 of each pixel 21 belonging to the second pixel unit 11B are equal to each other. On the other hand, in the charge reading, the first readout unit 13A outputs the first electrical signal of each column at a stage where charges generated in the pixels 21 corresponding to a first number of rows are accumulated in the first accumulation unit 12A, and the second readout unit 13B outputs the second electrical signal of each column at a stage where charges generated in the pixels 21 corresponding to a second number of rows smaller than the first number of rows are accumulated in the second accumulation unit 12B.

That is, for the pixels 21 of each column belonging to the first pixel unit 11A, the first electrical signal is output after a relatively large amount of charge is accumulated in the final potential well 42F, and the number of resetting of the charge is relatively reduced. Furthermore, for the pixels 21 of each column belonging to the second pixel unit 11B, the second electrical signal is output after a relatively small amount of charge is accumulated in the final potential well 42F, and the number of resetting of the charge is relatively increased. Even in such a configuration, the first pixel unit 11A and the second pixel unit 11B can be selectively used according to the mode of the spectroscopic spectrum image 31. Therefore, the spectroscopic spectrum data 32 of various types of the light L1 can be acquired with a favorable SN ratio.

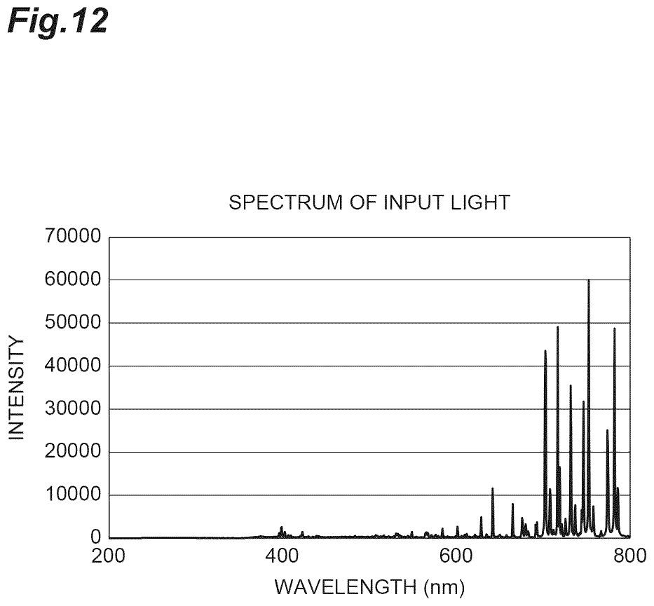

For example, as shown in FIG. 12, a case is considered in which light having a spectrum in which the signal intensity is relatively weak on the short wavelength side and the signal intensity is relatively strong on the long wavelength side is input to the spectroscopic device 5 in a wavelength-resolved state. In this case, it is conceivable that, when the spectroscopic spectrum image of the wavelength-resolved light is captured in a single pixel unit with a constant exposure time, the entire spectrum data on the short wavelength side is not saturated, but the S/N ratio cannot be sufficiently obtained, and the spectrum data on the long wavelength side has a favorable S/N ratio as a whole, but the spectrum data is saturated at a wavelength of a predetermined intensity or more.

On the other hand, in the example of FIG. 11, for example, the spectroscopic spectrum images 31A to 31C on the short wavelength side are captured by the first pixel unit 11A, and the spectroscopic spectrum images 31D and 31E on the long wavelength side are captured by the second pixel unit 11B. Further, for the pixels 21 of each column belonging to the first pixel unit 11A, the first electrical signal is output after a relatively large amount of charge is accumulated in the final potential well 42F, and for the pixels 21 of each column belonging to the second pixel unit 11B, the second electrical signal is output after a relatively small amount of charge is accumulated in the final potential well 42F.

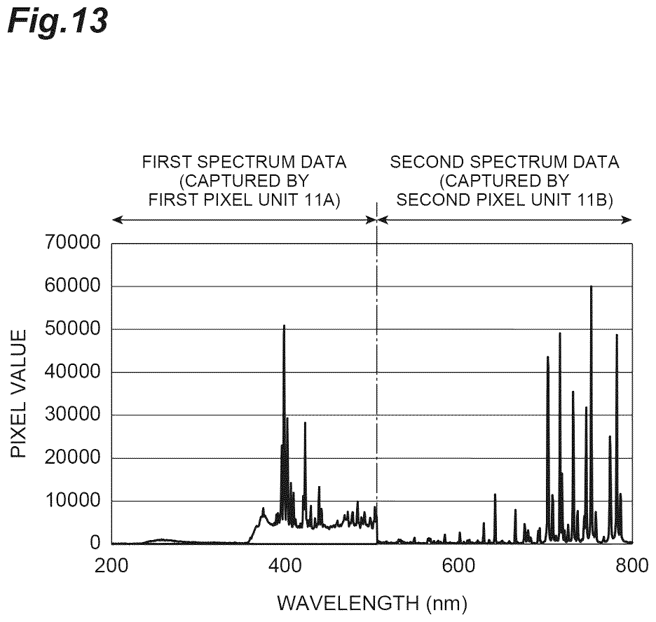

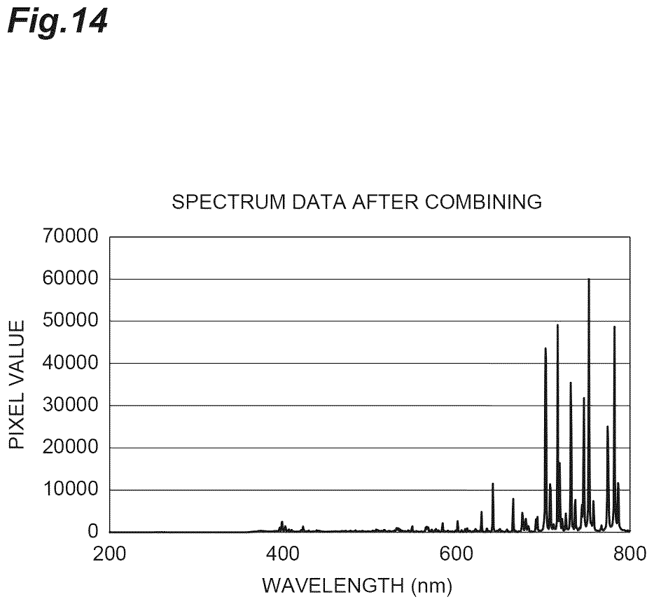

In this case, as shown in FIG. 13, the generation unit 15 generates the first spectrum data on the short wavelength side and the second spectrum data on the long wavelength side. In the first spectrum data, by outputting the first electrical signal after a relatively large amount of charge is accumulated, sensitivity to the spectroscopic spectrum images 31A to 31C is improved, and the SN ratio is improved. In the second spectrum data, by outputting the second electrical signal after a relatively small amount of charge is accumulated, saturation can be suppressed. Therefore, as shown in FIG. 14, by combining the first spectrum data and the second spectrum data to generate final spectroscopic spectrum data, spectroscopic spectrum data with a favorable SN ratio can be acquired in a high dynamic range.

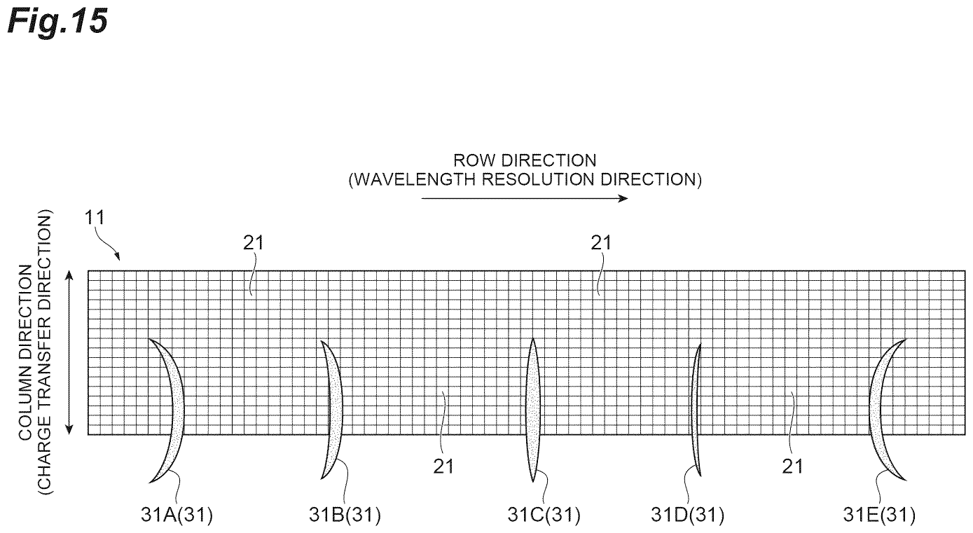

In general, as illustrated in FIG. 2, the spectroscopic spectrum images 31 (31A to 31E) are formed symmetrically with respect to the center of the pixel unit 11 in the column direction. However, as illustrated in FIG. 15, the spectroscopic spectrum images 31 (31A to 31E) may be formed at a position shifted in the column direction from the center of the pixel unit 11 in the column direction. It is assumed that the spectroscopic spectrum image 31 actually formed on the pixel unit 11 through the spectroscopic optical system 4 is not linear due to the influence of aberration of the optical system as represented by, for example, Czerny-Turner type spectroscopy.

For example, in the example of FIG. 15, the spectroscopic spectrum image 31C located at the center of the pixel unit 11 has a linear shape in the column direction, but in each of the spectroscopic spectrum images 31A and 31B and the spectroscopic spectrum images 31D and 31E, a so-called pincushion distortion occurs in which the image is curved toward the center side of the pixel unit 11. The distortion amount of the spectroscopic spectrum image 31 increases as the spectroscopic spectrum image is farther from the center of the pixel unit 11. The distortion amount of the spectroscopic spectrum images 31A and 31E is larger than the distortion amount of the spectroscopic spectrum images 31B and 31D.

In such a case, as illustrated in FIG. 15, by forming the spectroscopic spectrum images 31A to 31E shifted in the column direction from the center of the pixel unit 11 in the column direction, it is possible to exclude a portion having large distortion from imaging among the spectroscopic spectrum images 31A to 31E. Thereby, even when the spectroscopic spectrum images 31A to 31E are distorted, it is possible to suppress a decrease in wavelength resolution in the row direction in each of the spectroscopic spectrum data items 32A to 32E generated on the basis of the distortion. Furthermore, a decrease in peak value is also suppressed, and the SN ratio is also improved.

As another modification, the pixel unit 11 may not be necessarily divided into the first pixel region 21A and the second pixel region 21B, and may be configured by one pixel region. The spectroscopic device 5 is not limited to be applied to the Raman spectroscopic measurement device 1, and may be applied to other spectroscopic measurement devices such as a fluorescence spectroscopic measurement device, a plasma spectroscopic measurement device, and an emission spectroscopic measurement device. Furthermore, the spectroscopic device 5 may be applied to other spectroscopic measurement devices such as a film thickness measurement device, optical density measurement, laser-induced breakdown spectroscopy (LIBS) measurement, and differential optical absorption spectroscopy (DOAS) measurement.

### REFERENCE SIGNS LIST

1 Raman spectroscopic measurement device
2 light source unit
3 light guiding optical system
4 spectroscopic optical system
5 spectroscopic device
8 analysis unit
9 imaging element
10 semiconductor element
11 pixel unit
11A first pixel unit
11B second pixel unit
12 accumulation unit
12A first accumulation unit
12B second accumulation unit
13 readout unit
13A first readout unit
13B second readout unit
14 conversion unit
14A first conversion unit
14B second conversion unit
15 generation unit
31(31A to 31E) spectroscopic spectrum image
32(32A to 32E) spectroscopic spectrum data
L1 light
Lr Raman scattered light
T1 first exposure time
T2 second exposure time

1. A spectroscopic device receiving light wavelength-resolved in a predetermined direction by a spectroscopic optical system including a spectroscopic element to acquire spectroscopic spectrum data of the light, the spectroscopic device comprising:
a CCD type imaging element including:
a pixel unit including a plurality of pixels arranged in a row direction along a wavelength resolution direction of the light and in a column direction perpendicular to the row direction,
an accumulation unit arranged for each column at an end portion in the column direction of the pixel unit and accumulating charges generated in pixels of each column, and
a readout unit outputting an electrical signal of each column corresponding to a magnitude of the charges accumulated in the accumulation unit;
a semiconductor element converting the electrical signal of each column output from the readout unit into a digital signal and outputting the digital signal; and
a generation unit generating spectroscopic spectrum data on the basis of the digital signal output from the semiconductor element.

2. The spectroscopic device according to claim 1, wherein the imaging element includes:
a first pixel unit and a second pixel unit divided in the column direction,
a first accumulation unit and a second accumulation unit, the first accumulation unit being arranged for each column at an end portion in the column direction of the first pixel unit and accumulating charges generated in pixels of each column, and the second accumulation unit being arranged for each column at an end portion in the column direction of the second pixel unit and accumulating charges generated in pixels of each column, and
a first readout unit and a second readout unit, the first readout unit outputting a first electrical signal of each column corresponding to a magnitude of the charges accumulated in the first accumulation unit, and the second readout unit outputting a second electrical signal of each column corresponding to a magnitude of the charges accumulated in the second accumulation unit, and
the semiconductor element includes:
a first conversion unit converting the first electrical signal of each column output from the first readout unit into a digital signal and outputting the digital signal, and
a second conversion unit converting the second electrical signal of each column output from the second readout unit into a digital signal and outputting the digital signal.

3. The spectroscopic device according to claim 2, wherein a first exposure time of each pixel belonging to the first pixel unit is shorter than a second exposure time of each pixel belonging to the second pixel unit.

4. The spectroscopic device according to claim 3, wherein image data of a plurality of frames is acquired in the first pixel unit during a period in which image data of one frame is acquired in the second pixel unit.

5. The spectroscopic device according to claim 1, wherein the imaging element includes:
a first pixel unit and a second pixel unit divided in the row direction,
a first accumulation unit and a second accumulation unit, the first accumulation unit being arranged for each column at an end portion in the column direction of the first pixel unit and accumulating charges generated in pixels of each column, and the second accumulation unit being arranged for each column at an end portion in the column direction of the second pixel unit and accumulating charges generated in pixels of each column, and
a first readout unit and a second readout unit, the first readout unit outputting a first electrical signal of each column corresponding to a magnitude of the charges accumulated in the first accumulation unit, and the second readout unit outputting a second electrical signal of each column corresponding to a magnitude of the charges accumulated in the second accumulation unit.

6. The spectroscopic device according to claim 5, wherein the first readout unit outputs the first electrical signal of each column at a stage where charges generated in pixels corresponding to a first number of rows are accumulated in the first accumulation unit, and
the second readout unit outputs the second electrical signal of each column at a stage where charges generated in pixels corresponding to a second number of rows smaller than the first number of rows are accumulated in the second accumulation unit.

7. The spectroscopic device according to claim 1, further comprising an analysis unit analyzing the spectroscopic spectrum data.

8. The spectroscopic device according to claim 1, further comprising the spectroscopic optical system including the spectroscopic element.

9. A Raman spectroscopic measurement device comprising:
the spectroscopic device according to claim 1;
a light source unit generating light with which a sample is irradiated; and
a light guiding optical system guiding Raman scattered light generated by irradiating the sample with the light to the spectroscopic device.

10. A spectroscopic method of receiving light wavelength-resolved in a predetermined direction to acquire spectroscopic spectrum data of the light, the spectroscopic method comprising:
receiving the wavelength-resolved light by a plurality of pixels arranged in a row direction along a wavelength resolution direction and in a column direction perpendicular to the row direction;
accumulating charges generated in pixels of each column;
outputting an electrical signal of each column corresponding to a magnitude of the accumulated charges;
converting the electrical signal of each column into a digital signal and outputting the digital signal; and
generating spectroscopic spectrum data on the basis of the digital signal.
